(19) United States
(12) Patent Application Publication
(10) Pub. No.: US 2007/0156517 A1
(43) Pub. Date: Jul. 5, 2007

(54) System and method for redemption of a coupon using a mobile cellular telephone

(76) Inventors: Mark Kaplan, New York, NY (US); Colin Rand, Brooklyn, NY (US)

Correspondence Address: David A. Kalow, Esq.;Kalow & Springut LLP, 19th Floor, 488 Madison Avenue, New York, NY, 10022, US

(21) Appl. No.: 11/322,159

(22) Filed: Dec. 29, 2005

(51) Int. Cl. G06Q 30/00

(52) U.S. Cl. 705/14

(57) ABSTRACT

A system and a method for redeeming a coupon issued by a merchant are provided. The method includes the steps of receiving a text message transmitted by a user, determining a telephone number from which the text message was transmitted, debiting an amount corresponding to the value of the coupon from a merchant account, and depositing the amount into a user account. The coupon redemption message includes merchant identification and a value of the coupon. The user is sent a notification message, typically via the user's mobile cellular telephone, to inform the user that the amount corresponding to the coupon value has been deposited into the user account. Each of the accounts may be associated with an internet-based payment system. The value of the coupon may be expressible as either currency, mileage credit, points associated with a merchant loyalty program, or prepaid minutes of mobile cellular telephone usage.

### FIELD OF THE INVENTION

The present invention relates to text messaging using a mobile cellular telephone. More particularly, the present invention relates to a system and a method for automatic redemption of a merchant-issued coupon using text messaging from a mobile cellular telephone.

### BACKGROUND

The Internet is a significant venue for retail sales. Some internet transactions are made using a credit card, and some transactions are made using an alternative payment scheme, for instance PAYPAL (a trademarked name). Banner ads on websites may be used to generate interest in an internet retail purchase opportunity.

Radio frequency identification (RFID) tags may be used for tracking stock or other items (for instance, packages), and operate by passing the item in the region of a scanner. The scanner creates an electromagnetic field which interacts with the RFID tag causing the RFID tag to emit a radio signal. The radio signal emitted by the RFID tag may give various information, including a serial number indicating the identity of the item that has just been scanned.

RFID systems are conventionally used in supply chain management to track inventory, retail environments to enhance merchandise security, and at retail locations to initiate credit card payments.

An alternative identification system is the barcode system, which is composed of a symbol (for instance, a barcode) printed on the exterior of an item that is adapted to be read by a barcode reader, which may consist of a laser for reflecting off the barcode and a reader for receiving and interpreting the reflected image. Barcodes may be visually encoded numbers which are used to track inventory and identify products for most consumer packaged goods environments.

A magnetic strip reading system is used by swiping a magnetic strip past a reader and is conventionally used in credit card readers.

Mobile telephones are conventional, as are mobile phone originated SMS (Short Message Service) signals. SMS signals conventionally include a text message.

Optical character recognition (OCR) systems are currently used to extract text from images and are widely used in document management and document archival systems.

Interactive voice recognition (IVR) systems are phone based voice driven programs currently used in call support centers to provide customer assistance in making purchases and technical support.

Web banners are traditional display advertisements adapted to the World Wide Web to allow for interactive capabilities.

E-commerce Web Stores are product catalogues that have been adapted to the World Wide Web and enable product browsing and purchasing to create interactive shopping experiences.

Backend systems within the mobile and wireless communications industries are fragmented and incompatible. The fragmentation and system incompatibility within these markets makes seamless consumer communications and brand marketing cost prohibitive and functionally impractical. Conventionally, mobile operating systems communicate promotional content and information, without the ability to detect the user handset or integrate into 3rd party databases or systems. Current systems do not enable the purchasing of physical product, billing via premium SMS or integration into commercial databases, nor do they allow dynamic manipulation of their mobile content.

These systems are distinct and have not been integrated to provide users with a seamless, convenient and efficient shopping experience. Thus, a need exists to integrate technology to provide a more efficient shopping experience.

Merchant-issued coupons are conventional. Typically, when a consumer obtains a coupon, the consumer redeems the coupon upon purchase of an item at the merchant's place of business. In other instances, the consumer may redeem the coupon after purchasing an item by mailing the coupon to an address provided by the merchant, in conjunction with proof of purchase.

However, due to the increasing volume of business being transacted online via the Internet, many purchases are now made without a visit to the merchant's place of business. In addition, the use of standard mail to redeem a coupon is relatively slow and prone to problems, such as the coupon becoming “lost in the mail”. Therefore, there is a need for a system that takes advantage of mobile cellular telephone technology and the Internet to enable consumers to redeem merchant-issued coupons in an efficient and reliable manner.

### SUMMARY OF THE INVENTION

In one aspect, the invention provides a coupon redemption system. The system comprises a message module configured to receive a coupon redemption message transmitted by a user, and an account management module configured to credit an amount corresponding to the value of the coupon to an account accessible by the user and to debit the amount corresponding to the value of the coupon from an account accessible by the merchant. The coupon redemption message includes information identifying a merchant and information indicating a value of a coupon issued by the merchant. The message module is further configured to determine a telephone number associated with the transmission of the coupon redemption message. The message module and the account management module are coupled to one another via a network.

The system may also include a network interface coupled to the network and accessible by the user. The network interface may be configured to enable the user to obtain access to the user account. The account management module may be further configured to cause a notification message to be sent to a terminal that is accessible by the user. The notification message may include a notification to the user that the amount corresponding to the value of the coupon has been credited to the user account. The user terminal may be at least one of a telephone and a mobile cellular telephone. The notification message may be in the form of at least one of an SMS signal, an MMS signal, and a voice mail message. The network interface may include a client computer.

The coupon may include a bar code symbol. The system may further include a bar code reader configured to read the bar code symbol and to provide instructions to the user via the network interface. The instructions may be related to the transmission of the coupon redemption message. Alternatively, the coupon itself may include instructions relating to the transmission of the coupon redemption message. The coupon redemption message may be included in an SMS signal transmitted by the user. The coupon redemption message may be transmitted from a mobile cellular telephone.

The account management module may include a PAYPAL system. The value of the coupon may be expressible in one of the group consisting of currency, mileage credit, points associated with a merchant loyalty program, and prepaid minutes of mobile cellular telephone usage. The network may be the Internet.

In another aspect, the invention provides a method of redeeming a coupon issued by a merchant. The method includes the steps of receiving a coupon redemption message transmitted by a user, determining a telephone number from which the coupon redemption message was transmitted, debiting an amount corresponding to the value of the coupon from an account accessible by the merchant, and crediting the amount to an account accessible by the user. The coupon redemption message includes information identifying the merchant and information indicating a value of the coupon. The method may further include the step of enabling the user to obtain access to the user account.

The method may further include the step of sending a notification message to a terminal that is accessible by the user. The notification message may include a notification to the user that the amount corresponding to the value of the coupon has been credited to the user account. The user terminal may be at least one of a telephone and a mobile cellular telephone. The notification message may be in the form of at least one of an SMS signal, an MMS signal, and a voice mail message. The step of enabling the user to obtain access may include enabling the user to obtain access to the user account via a client computer on a network. The network may be the Internet.

The coupon may include a bar code symbol. The method may further include the step of enabling the user to obtain instructions related to the transmission of the coupon redemption message by scanning the bar code and using the client computer to decode a result of the scanning. Alternatively, the coupon itself may include instructions relating to the transmission of the coupon redemption message. The coupon redemption message may be included in an SMS signal transmitted by the user. The coupon redemption message may be transmitted from a mobile cellular telephone.

Each of the merchant-accessible account and the user account may be associated with a PAYPAL system. The value of the coupon may be expressible in one of the group consisting of currency, mileage credit, points associated with a merchant loyalty program, and prepaid minutes of mobile cellular telephone usage.

In yet another aspect of the invention, a computer-readable storage medium containing a set of instructions for a processor is provided. The set of instructions includes receiving at the processor a coupon redemption message transmitted by a user, determining a telephone number from which the coupon redemption message was transmitted, debiting an amount corresponding to the value of the coupon from an account accessible by the merchant, and crediting the amount to an account accessible by the user. The coupon redemption message includes information identifying the merchant and information indicating a value of the coupon. The set of instructions may further include enabling the user to obtain access to the user account via a client computer on the Internet.

The set of instructions may further include sending a notification message to a terminal that is accessible by the user. The notification message may include a notification to the user that the amount corresponding to the value of the coupon has been credited to the user account. The user terminal may be at least one of a telephone and a mobile cellular telephone. The notification message may be in the form of at least one of an SMS signal, an MMS signal, and a voice mail message. The coupon redemption message may be included in an SMS signal transmitted by the user. The coupon redemption message may be transmitted from a mobile cellular telephone.

Each of the merchant-accessible account and the user account may be associated with a PAYPAL system. The value of the coupon may be expressible in one of the group consisting of currency, mileage credit, points associated with a merchant loyalty program, and prepaid minutes of mobile cellular telephone usage.

These and other features and aspects of the present invention will be better understood with reference to the following figures and detailed description.

### BRIEF DESCRIPTION OF THE DRAWINGS

FIG. 1 illustrates a block diagram of a server system that is configured to accept content input from a mobile device, according to an exemplary embodiment of the invention.

FIG. 2 illustrates an exemplary merchant-issued coupon that includes instructions for how to redeem the coupon by sending a text message, according to an exemplary embodiment of the invention.

FIG. 3 illustrates a block diagram of an exemplary coupon redemption system according to an exemplary embodiment of the invention.

FIG. 4 illustrates a block diagram of a user terminal that enables the user to access an account into which a deposit is made in conjunction with the coupon redemption, according to an exemplary embodiment of the invention.

FIG. 5 illustrates a flow chart for an exemplary method of redeeming a merchant-issued coupon using text messaging from a mobile cellular telephone, according to an exemplary embodiment of the invention.

### DETAILED DESCRIPTION OF THE INVENTION

The present invention relates generally to the field of mobile (GSM, CDMA, TDMA, 3G, EVDO, etc . . . ) and wireless (Wi-Fi, Wi-Max, etc . . . ) communications. More specifically, the present invention is related to the development of a fully integrated system for processing, distributing and routing communications between IP and telecommunications systems, and to enabling a consumer to use these systems to redeem merchant-issued coupons automatically by sending a text message in accordance with instructions included on the coupon. The system provides interactive consumer experiences and brand communications across Internet, mobile, wireless, physical spaces and traditional marketing to enable commerce and community building functionality.

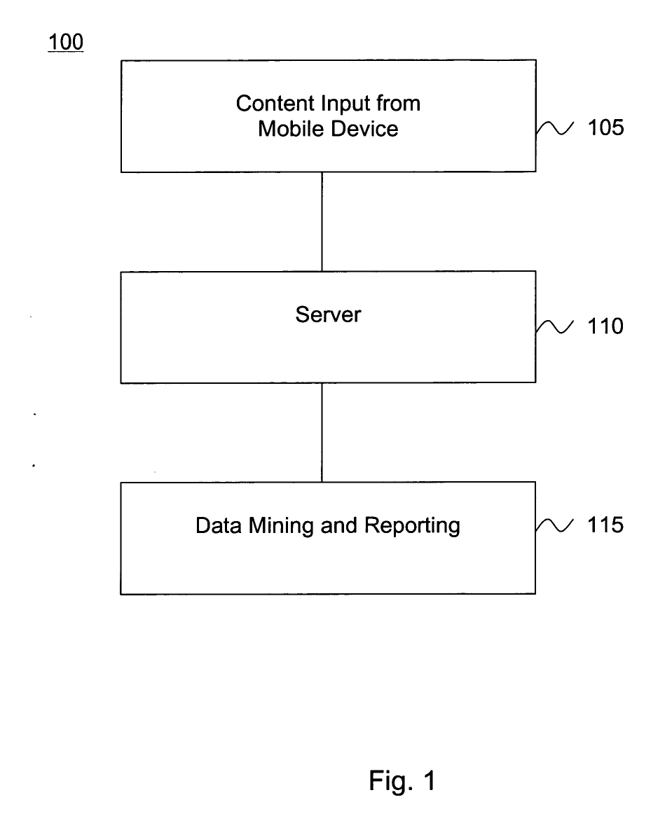

FIG. 1 shows an exemplary system 100 according to the present invention. Element 110 is a server, also referred to herein as an integrated mobile application server and communication gateway. Server 110 may be implemented, for example, by using a general purpose computer or a personal computer. Server 110 may be connected to a network, such as one or more of a local area network (LAN), a wide area network (WAN), and the Internet. Server 110 includes an authorization and queue application, a loyalty application, a transaction database, and a database of user profiles. Alternatively or additionally, server 110 may access another server or other memory for any or all of these functions or features. Server 110 may be accessed by a web interface, for instance a web banner interface. For example, a user may input a mobile phone number in a web banner as a method of initiating a purchase of a mobile device download, for instance a ringtone, game, picture, video, or other download. Inputting the mobile phone number may access a previously formed account identified by the mobile phone number. The account may include billing information. In the event that no previously formed account for the inputted mobile phone number exists, the web interface may direct the user to set-up an account, by for instance creating a new web interface or redirecting the existing web interface.

The user may set up an account by inputting personal information, a mobile phone number or numbers, personal preferences, and/or payment information. Payment information may be any of credit card information, PAYPAL or another appropriate web-based payment system, and/or a mobile telecommunication billing plan.

After the user inputs the mobile phone number in the web banner or other web interface, and after the mobile phone number is associated with an existing account, server 110 associates the authorization with the requested download in a queue. Server 110 would then send an SMS message to the mobile phone to confirm the purchase and download and thereby confirm that the person inputting the information in the web banner interface is the owner of the phone and the person listed in the user profile. The SMS message would require a response, which may be simply a reply, a simple affirmative response (e.g., “yes”), and/or may be a response including a personal identification number.

After the authorizing response, server 110 would send the download to the mobile device and would complete the billing to the selected payment plan. Additionally, server 110 would also log the transaction in a transaction database and/or input the purchase into a loyalty program to assist in future marketing efforts directed at the consumer.

A mobile device 105 may be used to input content into server 110. The type of content that is input into server 110 may include photos, ringtones, games, videos, and/or any other appropriate download for a mobile device 105. The mobile device 105 may be one of the following exemplary types of mobile devices: a mobile cellular telephone, WAP mini sites, asset hosting (which may represent a mobile telecommunication company, a mobile barcode, and a MMS, WAP push, or SMS messaging service. In particular, the mobile barcode may allow the user of a mobile phone, in which the mobile phone has a picture-taking capability, to take a picture of a barcode and send the picture to server 110. The user would also authorize server 110 to complete a purchase of the item having the barcode. The purchase may be fulfilled through an online retailing system operated in conjunction with server 110 and/or through another online retailer. Server 110 may access a user profile and/or a billing selection when a mobile device 105 sends a picture image of a barcode in this manner.

Connecting to server 110 from the bottom of FIG. 1 is an arrow leading out of server 110 to a data mining and reporting box 115, which indicates a reporting function that leverages information in any of the user profile component, the loyalty component, and/or the transaction component of server 110 for the preparation of a report. A data mining or other report prepared in this manner may be useful for marketing, planning, or any other business function.

An RFID interface for server 110 may provide a location-based download for a user having an RFID which is associated with a user profile, user account, and/or payment plan. The user may initiate a purchase by arranging the RFID in proximity to an RFID interface (for instance a scanner/reader). The RFID interface may then initiate the purchasing operation by sending the unique RFID tag and selected item to server 110. The remainder of the purchasing operation may proceed in the same manner as the purchasing operation described above in the context of a web interface.

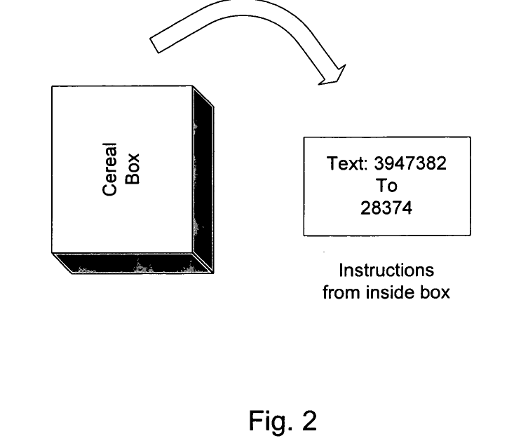

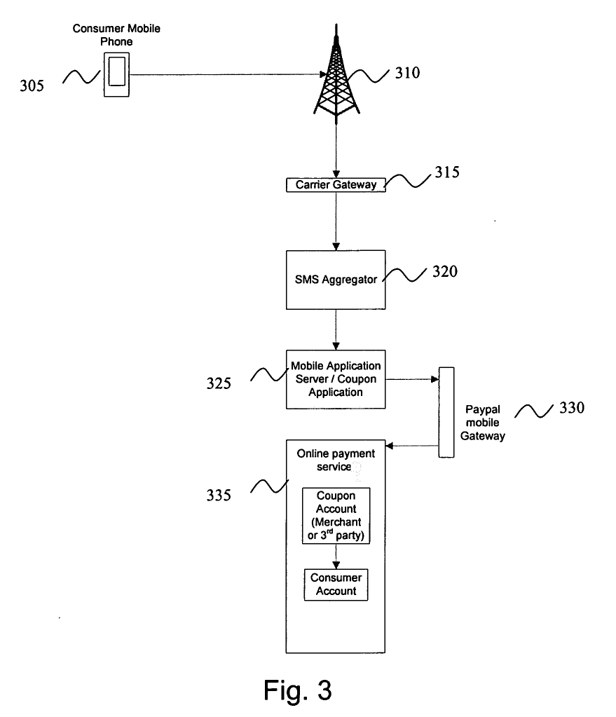

FIG. 2 illustrates an exemplary coupon issued by a merchant according to an exemplary embodiment of the invention. Referring also to FIG. 3, a block diagram of an exemplary coupon redemption system according to an exemplary embodiment of the invention is illustrated. In the example illustrated in FIG. 2, a typical consumer purchases a box of cereal from a grocery store or supermarket. Inside the box is a coupon, such as the one shown in FIG. 2. The coupon contains instructions which direct the consumer to send a text message to a certain telephone number. The telephone number may be indicated using either short code or standard code. The text message itself is typically in the format of an SMS signal.

Typically, the consumer will use a mobile cellular telephone 305 to send the text message. The text message is relayed via base station 310 and carrier gateway 315 associated with the consumer's mobile network service provider. The text message is then routed through an SMS aggregation service 320 to a mobile coupon application server 325, which may be one of many applications that is handled by server 110. The telephone number from which the text message was sent is also provided to the server 325.

Upon receipt of the text message, the coupon application server 325 then processes the coupon. First, the server 325 decodes the content of the text message to determine the identity of the merchant and the value of the coupon. Using both the merchant identity and the telephone number from which the text message was sent, the server 325 interfaces with an online payment service 335, for example, a PAYPAL service, either directly or perhaps through a PAYPAL mobile gateway 330. The online payment service 335 provides access to both a merchant account and a consumer account.

The coupon application server 325 transmits the decoded content from the text message to the online payment service 335. The service 335 uses this information to debit the merchant account in the amount indicated by the value of the coupon, and to credit the consumer account by the same amount, i.e., deposit that amount into the consumer account. Upon completion of the debiting and crediting/depositing, a message may be transmitted, perhaps in the form of an e-mail over the Internet, a voice mail message to the consumer's mobile cellular telephone, or an SMS message to the consumer's mobile cellular telephone, to notify the consumer that the coupon has been successfully redeemed by depositing the amount into the consumer account.

In an exemplary embodiment of the present invention, the user may or may not have created a user account prior to redeeming a mobile coupon. If the user has created the user account prior to redeeming the coupon, the creation process included associating the account with a mobile telephone number of the user's mobile telephone. When redeeming the mobile coupon, the user telephones the number indicated on the mobile coupon from the mobile telephone from the associated account and inputs or text messages a code from the mobile coupon. The server identifies the mobile telephone number, verifies the coupon code, debits the merchant account, and credits the user account. Then the server sends a message, for instance an SMS message, to the user's mobile telephone number. However, if the user has not previously set up a user account, which situation the server would recognize upon receiving a mobile coupon code from an unknown mobile telephone number, the server creates an account associated with that mobile telephone number, and debits the merchant account in the manner described herein. The server would also send the confirmation message to the user in the same manner as described herein, along with addition information to indicate how the user may access the account created by the server. This account may be accessed by the mobile telephone using SMS messages or voice recognition with a computer or live operator, with a landline telephone in the same manner as a mobile telephone, or by a computer connected to the Internet.

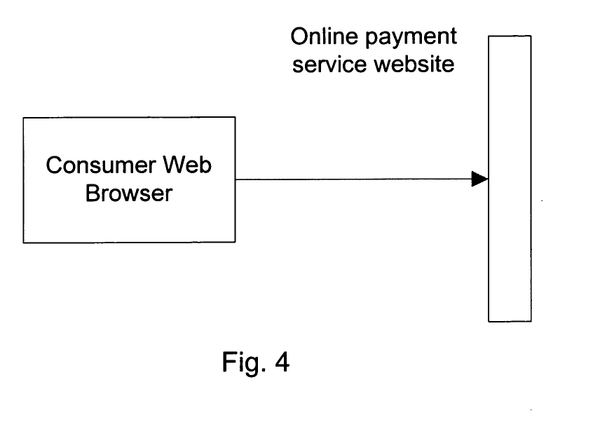

Referring to FIG. 4, the consumer may use a web browser to access a web site operated by the online payment service to view the consumer account. In this manner, the consumer may verify that the account has been properly credited. Advantageously, the combination of features of the present invention enable a consumer to redeem a coupon and verify deposit of the coupon value in a consumer account completely through the use of a mobile cellular telephone and a computer terminal having access to the Internet, from any place, without any further restrictions.

In many instances, the value of the coupon is expressible in currency, for example, dollars and cents or Euros. In such instances, the value of the coupon can be deposited in a standard bank account, such as a checking account or savings account, or any other standard type of account into which money may deposited or withdrawn. Alternatively, the value of a coupon may be expressible in other forms. Coupons may be redeemable for service credits that relate to specific merchants. For example, frequent flyer miles relating to one or more airlines may be provided in a coupon. Other examples may include prepaid mobile cellular telephone minutes, STARBUCKS (a trademarked name) coffee card credit, or loyalty points as part of a merchant loyalty program.

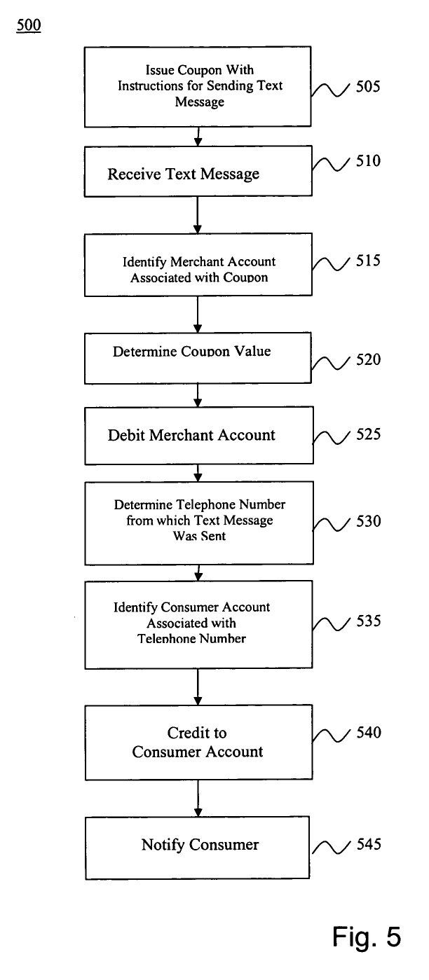

Referring to FIG. 5, a flow chart 500 illustrates a method of redeeming a coupon according to an exemplary embodiment of the present invention. In the first step 505, a merchant issues a coupon, which is typically made available in conjunction with the purchase of a consumer item. Alternatively, the coupon may be issued in conjunction with the purchase of a service, a reward for attendance, a purchase of a download, or in any other appropriate manner. The coupon includes instructions for sending a text message, preferably from a mobile cellular telephone. When a consumer purchases the appropriate item or otherwise obtains the coupon and follows the instructions by sending a text message such as that shown in FIG. 2, the text message is received at step 510. Then, at steps 515 and 520, the text message is decoded to determine the identity of the merchant, an account associated with that merchant, and the value of the coupon. The merchant account is then debited according to the value of the coupon at step 525. At step 530, the telephone number from which the text message was sent is determined. Using this telephone number, a consumer account is identified at step 535. Then, an amount corresponding to the value of the coupon is credited to the consumer account at step 540. Finally, the consumer is notified of the successful redemption of the coupon by e-mail, voice mail, text message, or any other appropriate method at step 545. These steps may be performed in any appropriate order. In particular, the crediting of the consumer account may be performed before the debiting of the merchant account. Additionally, as discussed above, if no consumer account is associated with the telephone number in step 535, the server may create a user account associated with the telephone number for crediting the coupon amount. In this case, the notification of the consumer in step 545 would also include instructions for accessing the consumer account.

In an alternative embodiment, the coupon redemption system of the present invention may be implemented as an instant rebate system for a situation in which a user uses a mobile cellular telephone with a mobile commerce platform to purchase an item directly by transmitting a text message. In this embodiment, when a consumer purchases an item by text messaging from a mobile phone, the instant rebate automatically causes a credit to be provided to the consumer's account, using the same methodology as that described above.

In another alternative embodiment, the instructions for sending a text message contained in the coupon may be in the form of a bar code, a picture, or a graphic icon that is designed to be read using a bar code reader, an optical scanner, or a software interpretation program. In these instances, the instructions may be provided to the consumer, for example, by scanning the bar code or interpreting the symbol and then obtaining a printout or an e-mail message that provides instructions for redeeming the coupon. Alternatively, a user may take a photo of the barcode using a mobile telephone equipped with a camera and send the image to a designated number as an alternative method of initiating the coupon redemption.

Additionally, the present invention provides for an article of manufacture comprising computer readable program code contained within implementing one or more modules to aid in the redemption of a merchant-issued coupon as described above. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, -EPROM, RAM, ROM, DRAM, SRAM, SDRAM, or any other appropriate static or dynamic memory or data storage devices.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto may be stored in computer memory, static or dynamic, and may be retrieved by the user in any of: conventional computer storage, display (i.e., CRT) and/or hardcopy (i.e., printed) formats. The programming of the present invention may be implemented by one of skill in the art of wireless applications and web-based programming.

This application discusses specific embodiments of the present invention. The specific features described herein may be used in some embodiments, but not in others, without departing from the spirit and scope of the invention as set forth in the foregoing disclosure. It will be appreciated by those of ordinary skill in the art that the illustrative examples do not define the metes and bounds of the invention. For example, the present invention should not be limited by software/program, computing environment, or specific computing hardware. As another example, although the use of a mobile cellular telephone is discussed, a standard land-line telephone or a computer terminal having Internet access may be used to send a text message to a server to cause a coupon to be redeemed according to the present invention.

What is claimed is:

1. A coupon redemption system, comprising:
a message module configured to receive a coupon redemption message transmitted by a user, the coupon redemption message including information identifying a merchant and a value of a coupon issued by the merchant, and the message module being further configured to determine a telephone number associated with the transmission of the coupon redemption message; and
an account management module configured to credit an amount corresponding to the value of the coupon to a user account associated with the telephone number,
wherein the message module and the account management module are coupled to one another via a network.

2. The system of claim 1, wherein the account management module is further configured to debit the amount corresponding to the value of the coupon from an account accessible by the merchant.

3. The system of claim 1, further comprising a network interface coupled to the network, the network interface being accessible by the user, the network interface being configured to enable the user to one of obtain access to the user account and create the user account.

4. The system of claim 3, wherein the account management module is further configured to cause a notification message to be sent to a terminal that is accessible by the user, wherein the notification message includes a notification to the user that the amount corresponding to the value of the coupon has been credited to the user account.

5. The system of claim 4, wherein the user terminal is at least one of a telephone and a mobile cellular telephone, and wherein the notification message is in the form of at least one of an SMS signal, an MMS signal, and a voice mail message.

6. The system of claim 1, wherein the coupon includes a bar code symbol, and the system further comprises a bar code reader configured to read the bar code symbol and to provide instructions to the user, the instructions being related to the transmission of the coupon redemption message.

7. The system of claim 1, wherein the coupon includes instructions relating to the transmission of the coupon redemption message.

8. The system of claim 1, wherein the coupon redemption message is included in an SMS signal transmitted by the user.

9. The system of claim 1, wherein the coupon redemption message is transmitted from a mobile cellular telephone.

10. The system of claim 1, wherein the account management module comprises an internet-based payment system.

11. The system of claim 1, wherein the value of the coupon is expressible in one of the group consisting of currency, mileage credit, points associated with a merchant loyalty program, and prepaid minutes of mobile cellular telephone usage.

12. The system of claim 1, wherein the network comprises the internet.

13. A method of redeeming a coupon issued by a merchant, the method comprising:
receiving a coupon redemption message transmitted by a user, wherein the coupon redemption message includes information identifying the merchant and a value of the coupon;
determining a telephone number from which the coupon redemption message was transmitted; and
crediting an amount corresponding to the value of the coupon to a user account associated with the telephone number.

14. The method of claim 13, further comprising debiting the amount from an account accessible by the merchant.

15. The method of claim 13, further comprising enabling the user to one of obtain access to the user account and create the user account.

16. The method of claim 13, further comprising sending a notification message to a terminal that is accessible by the user, wherein the notification message includes a notification to the user that the amount corresponding to the value of the coupon has been credited to the user account.

17. The method of claim 16, wherein the user terminal is at least one of a telephone and a mobile cellular telephone, and wherein the notification message is in the form of at least one of an SMS signal, an MMS signal, and a voice mail message.

18. The method of claim 13, wherein enabling the user to obtain access further comprises enabling the user to obtain access to the user account via a client computer on a network.

19. The method of claim 18, wherein the coupon includes a bar code symbol, and the method further comprises the step of enabling the user to obtain instructions related to the transmission of the coupon redemption message by scanning the bar code and using the client computer to decode a result of the scanning.

20. The method of claim 13, wherein the coupon includes instructions relating to the transmission of the coupon redemption message.

21. The method of claim 13, wherein the coupon redemption message is included in an SMS signal transmitted by the user.

22. The method of claim 13, wherein the coupon redemption message is transmitted from a mobile cellular telephone.

23. The method of claim 13, wherein each of the merchant-accessible account and the user account is associated with an internet-based payment system.

24. The method of claim 13, wherein the value of the coupon is expressible in one of the group consisting of currency, mileage credit, points associated with a merchant loyalty program, and prepaid minutes of mobile cellular telephone usage.

25. A computer-readable storage medium containing a set of instructions for a processor, the set of instructions comprising:
receiving at the processor a coupon redemption message transmitted by a user, wherein the coupon redemption message includes information identifying the merchant and a value of the coupon;
determining a telephone number from which the coupon redemption message was transmitted; and
crediting an amount corresponding to the value of the coupon to a user account associated with the telephone number.

26. The computer-readable storage medium of claim 25, the set of instructions further comprising debiting the amount from an account accessible by the merchant.

27. The computer-readable storage medium of claim 25, the set of instructions further comprising enabling the user to one of obtain access to the user account via a client computer on the internet and create the user account via the client computer.

28. The computer-readable storage medium of claim 25, the set of instructions further comprising sending a notification message to a terminal that is accessible by the user, wherein the notification message includes a notification to the user that the amount corresponding to the value of the coupon has been credited to the user account.

29. The computer-readable storage medium of claim 28, wherein the user-accessible terminal is at least one of a telephone and a mobile cellular telephone, and wherein the notification message is in the form of at least one of an SMS signal, an MMS signal, and a voice mail message.

30. The computer-readable storage medium of claim 25, wherein the coupon redemption message is included in an SMS signal transmitted by the user.

31. The computer-readable storage medium of claim 25, wherein the coupon redemption message is transmitted from a mobile cellular telephone.

32. The computer-readable storage medium of claim 25, wherein each of the merchant-accessible account and the user account is associated with an internet-based payment system.

33. The computer-readable storage medium of claim 25, wherein the value of the coupon is expressible in one of the group consisting of currency, mileage credit, points associated with a merchant loyalty program, and prepaid minutes of mobile cellular telephone usage.
